(19) United States
(12) Patent Application Publication
(10) Pub. No.: US 2026/0068022 A1
(43) Pub. Date: Mar. 5, 2026

(54) SYSTEM AND METHODS FOR SHEAR FLOW CONTROL OF FRC PLASMA

(71) Applicant: TAE TECHNOLOGIES, INC., Foothill Ranch, CA (US)

(72) Inventors: Toshiki Tajima, Foothill Ranch, CA (US); Hiroshi Gota, Irvine, CA (US)

(21) Appl. No.: 19/064,897

(22) Filed: Feb. 27, 2025

Related U.S. Application Data
(63) Continuation of application No. PCT/US23/30808, filed on Aug. 22, 2023.
(60) Provisional application No. 63/401,787, filed on Aug. 29, 2022.

(51) Int. Cl. H05H 1/10

(52) U.S. Cl. CPC H05H 1/10

(57) ABSTRACT

A high performance field reversed configuration (FRC) system includes a central confinement chamber, two diametrically opposed compact toroid plasma injectors coupled to the chamber, two divertor chambers interposing the injectors and the chamber, and opposing sets of biasing electrodes. A magnetic system includes quasi-dc coils axially positioned along the FRC system components.

### CROSS-REFERENCE TO RELATED APPLICATIONS

The subject application is a continuation of International Patent Application No. PCT/US2023/030808, filed Aug. 22, 2023, which claims priority to U.S. Provisional Patent Application No. 63/401,787, filed Aug. 29, 2022, both of which are incorporated by reference herein in their entireties for all purposes.

### FIELD

The embodiments described herein relate generally to magnetic plasma confinement systems and, more particularly, to systems and methods that facilitate flow control of a Field Reversed Configuration (FRC) plasma.

### BACKGROUND

The Field Reversed Configuration (FRC) belongs to the class of magnetic plasma confinement topologies known as compact toroids (CT). It exhibits predominantly poloidal magnetic fields and possesses zero or small self-generated toroidal fields (see M. Tuszewski, Nucl. Fusion 28, 2033 (1988)). The attractions of such a configuration are its simple geometry for ease of construction and maintenance, a natural unrestricted divertor for facilitating energy extraction and ash removal, and very high β (β is the ratio of the average plasma pressure to the average magnetic field pressure inside the FRC), i.e., high power density. The high β nature is advantageous for economic operation and for the use of advanced, aneutronic fuels such as D-He3 and p-B11.

Improved systems, devices, and methods to control FRC plasmas by inducing and/or imposing flows that are with or without shear.

### SUMMARY

Example embodiments of systems, devices, and methods are provided herein for the generation and maintenance of a high flux target FRC plasma and the control of the FRC plasma by imposing shear flows from outside the FRC. In example embodiments, an FRC confinement system includes a confinement chamber, an opposing pair of divertors coupled to the ends of the chamber, an opposing pair of compact toroid plasma injectors opposingly coupled to the divertors, and opposing sets of electrodes positioned within the divertors and used to facilitate imposing shear flows from outside the FRC plasma positioned within the confinement chamber. In example embodiments, the opposing sets of electrodes or aside electrodes each comprise a set of mutually insulated electrodes with mutually different voltages and are used to apply sufficiently strong electric fields in a strategic fashion to cause favorable flows and shear flows in the scrape-off layer (SOL) of the FRC plasma. These voltages produce E×B shear flows that are primarily in the azimuthal direction or flows that are primarily in the axial direction of the SOL plasma. When the shear flow velocity v_{θ}′ exceeds a certain value that is related to parameters, such as, e.g., the FRC density gradient length, the plasma in the SOL tends to behave well both in its stability and transport. When the axial flow is induced in the reverse direction to the transport loss direction, it tends to mitigate the plasma loss.

In an example embodiment, an individual electrode includes a grid or set of grids positioned adjacent a plasma facing or conducting surface of the electrode.

In an example embodiment, an individual electrode includes a plurality of electrically-conducting carbon nanotube filamentary fingers extending from a plasma facing or conducting surface of the electrode.

In an example embodiment, an individual electrode includes an insulating material comprising, e.g., a two-dimensional carbon structure of graphene and affixed to the electrode.

In an example embodiment, the insulating material comprises a carbon net.

Other systems, devices, methods, features and advantages of the subject matter described herein will be or will become apparent to one with skill in the art upon examination of the following figures and detailed description. It is intended that all such additional systems, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1 is a partial schematic of an example embodiment of adjacent electrodes depicting the direction of magnetic flux lines and electric field Eᵣ by the side of scrape-off layer (SOL) of the FRC plasma.

FIG. 2A is a partial schematic of an example embodiment of opposing sets of adjacent electrodes aligned across from each other along magnetic flux lines. This may be applicable both for the axial flows and for possible shear flows.

FIG. 2B is a partial schematic of an example embodiment of an individual electrode from the opposing sets of adjacent electrodes shown in FIG. 2A.

FIG. 3 is a partial schematic depicting an example embodiment of an individual electrode with a grid or set of grids interposing a plasma facing conducting surface of the electrode and a plasma.

FIG. 4 is a partial schematic depicting an example embodiment of an individual electrode with a plurality of electrically-conducting carbon nanotube filamentary fingers extending from a plasma facing conducting surface of the electrode.

FIG. 5 is a partial schematic depicting an example embodiment of an individual electrode with an insulating material comprising, e.g., a two-dimensional carbon structure of graphene and affixed to the electrode.

FIGS. 6A, 6B, 6C, 6D and 6E are schematics depicting top, perspective, front, partial elevation and cross-sectional views of an example embodiment of a carbon net.

FIG. 7 is a schematic of a plasma gun.

FIGS. 8A and 8B are photographic images of an electron gun.

FIG. 9 is a schematic depicting an example embodiment of an FRC confinement system with a central confinement chamber, opposing divertors coupled to the ends of the confinement chamber, electrodes positioned within the electrodes and opposing compact toroid injectors extending from the divertors.

FIG. 10 is a schematic depicting an example current path from electrodes, where arrows on the magnetic-field lines represent current path for a negative biasing scheme on the end electrodes. Applied potentials at end electrodes (i.e., Eᵣ) are translated along magnetic-field lines to create azimuthal shear flow v_{θ}(z,r) and azimuthal magnetic field B_{θ}(z) in the SOL of FRC plasma.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

There are at least two approaches to implement stabilizing and confinement enhancing measures. The first approach includes radial shear flows, while the second approach includes axial flows in the FRC plasma.

In the first approach, an external voltage (and other measures) is implemented to realize the plasma flows in the azimuthal direction to acquire the radial variations so that the plasma wave structure due to plasma instability and possible turbulence, and deleterious plasma flows and transport, can be broken down, reduced, or remedied by radial truncation, reduction, or suppression. An equivalent method to the first approach has been shown for a tokamak plasma case (see Ref. [1]) and works to reduce the tokamak radially extended plasma leak with the leak over extended radial structures being mitigated and suppressed to lead to a reduced transport loss (or better confinement regime, called the High Regime).

In the second approach, an external voltage (or other measures) is implemented to induce two sets of influences on the SOL plasma. One is similar to the cascade of excited shear-induced breakdown of the plasma wave structure that can reduce the plasma anomalous transport. The other is a new phenomenon described below.

The way to induce the azimuthal plasma flows as a function of the axial position (and thus a shear flow in the azimuthal direction as a function of the axial position) may be considered as follows. The end-plate voltage application Eᵣ leads to the azimuthal plasma rotation flow v_{θ}=cEᵣ×B₂/B_{z}² (see FIG. 10). This flow drags the plasma's magnetohydrodynamic (MHD) fields B_{θ}. This azimuthal magnetic field can induce both radial current Jᵣ=∇_{z}×B_{θ} and the axial current J_{z}=∇ᵣ×B_{θ}. From Jᵣ the plasma is driven to produce a flow by the axial force F_{z}=Jᵣ×B_{θ}. Such a chain of MHD reactions for a FRC plasma are analogous to an astrophysical observation (see Ref. [16]) of a jet formation. In a FRC plasma an inward plasma flow is created by the applied voltage appropriately designed at the end-plates of the two opposing side-ends (see FIG. 10). In this case, an axial magnetic field is induced to become a spiraling magnetic field with an inward additional flow. (see sections 4.2 and 4.3 of Ref. [16]). In this second approach of voltage application, the mirror axial magnetic fields are induced to begin to wind azimuthally at a local axial position such as the mirror throat. These fields form a spiraling magnetic field shear flow and tend to induce inward plasma flows and a current loop. In general, the realized flows with shear may be given as v_{θ}(r) as well as v_{θ}(z). The latter can cause the above mentioned “spiral” magnetic fields. Thus, as a result, the sheared magnetic fields are obtained as well: B_{θ}(r) and B_{θ}(z).

In FIG. 10 an example is shown of the external voltage application and its distributed voltage and, thus, its resultant flow velocity induced by these voltages (and the plasma electric fields), which also should result in magnetic shears (in both z and r). Their impacts on plasma are varied so that both or each separately are available to have combined or separate effects, respectively. For example, the radial velocity shear v_{θ}(r) can incur the more localized plasma wave developments, such as truncation of the radially extended larger fluctuations (or so-called “islands” in electric potential, which indicates the size of plasma particle and heat migration characteristics). On the other hand, v_{θ}(z) could induce associated magnetic shear (see Ref. [16]), which can also influence the plasma properties. By a proper choice of the voltage sign, such an induced plasma flow may be inflow so that the plasma may tend to be stored more inward. This may be particularly the case in the SOL region. However, the shear flow effects may also be possible, which could influence the stability and confinement of the core as well. In the example in FIG. 10, the flow shears have both radial and axial variations.

A FRC plasma 453 includes the following portions: the core (within the FRC 450), the SOL (beyond the separatrix), and the expander/divertor (within the expander/diverter 302). The control and improvement of the operation of the FRC plasma include the control of the plasma behavior through the external injection of voltage or current (via plates 12, for example) and the external injection of particles (or their current) (see Ref. [17]). Similarly, the shear flow E×B by the side-plate voltages can induce the shear flows in the SOL plasma that break down the island structure of the instability-driven electric turbulence, which tend to mitigate the radial transport of the SOL.

In the past (see Ref. [17]) the end-plates with different voltage application have been suggested, which can lead to the induction of the electric fields near the end points (such as near the mirror throat region) that amount to the shear plasma flows (E×B flow) and the associated plasma current. Some of the voltage plates may be placed away from the mirror end (such as just outside of or near the mid-core region). As to the injection of particles to induce the plasma current (see Ref. [18]), the placement of injected beams may be near the center of the core or SOL plasma.

Such controls can change the plasma behaviors of a FRC plasma such as in the SOL or in the core. For example, the application of the shear flow of the SOL by the imposed voltage application by the end-plates can lead to the E×B plasma flow in the primarily toroidal direction as a function of r or z. The r-dependent plasma flow can give rise to the sheared plasma structure in the SOL and to allow the narrower (smaller) radial mode structure of drift wave instabilities. On the other hand, the z-dependent plasma flow may allow to produce the induction of plasma current (in r-z plane) to form a toroidally-sheared magnetic fields which in turn can yield axial plasma flow (see Ref. [16]). These influences on the FRC plasma in turn change the typical plasma behaviors. The control parameter such as the shear length Lₛ (or the density scale length Lₙ or the temperature scale length L_{T}) may be modified by such plasma behaviors, including the possible reduction of Lₛ.

On the other hand, the control plasma parameters such as Lₛ (Lₙ or L_{T}) give rise to the internal plasma behaviors such as in the core of the FRC plasma. This is regarded as a result of the more stabilized SOL plasma making the core plasma more benign, for example. In the embodiments provided herein, the core plasma stability and transport is improved via better control of the SOL (and the end plasma/divertors), which is characterized as well as the more theoretically precise plasma control through the selected control parameter through the above control.

As discussed below, a sequence of methods is provided that institute better and stronger control of plasma via the injection of voltage/current and particle flows.

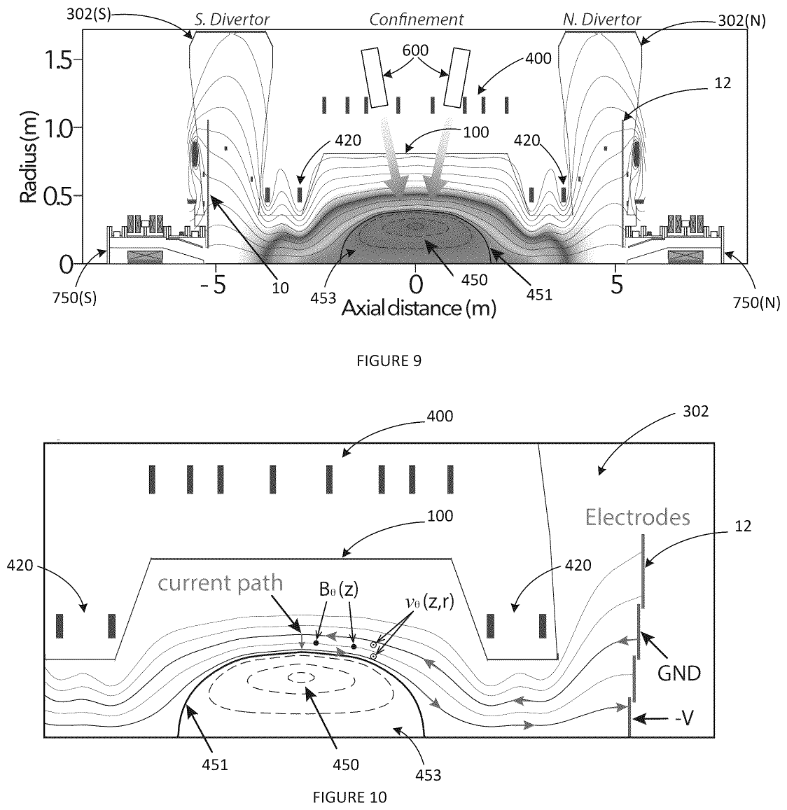

The present disclosure is directed to systems, devices and methods that facilitate the generation and maintenance of a high flux target FRC plasma and the control of the FRC plasma by imposing shear flows from outside the FRC 450. FIG. 9 depicts an example embodiment of an FRC plasma confinement system having a confinement chamber 100, a magnetic system comprising a series quasi-dc coils 400 and pairs of mirror coils 420 positioned about the confinement chamber, an opposing pair of divertors coupled 302(S) and 302(N) to the ends of the chamber, an opposing pair of compact toroid plasma injectors 750(S) and 750(N), e.g., spheromak injectors, are opposingly coupled to the divertors, and opposing sets of electrodes 10 and 12 that are positioned within the divertors and used to facilitate imposing shear flows from outside the FRC plasma 453 positioned within the confinement chamber. The opposing sets of electrodes 10 and 12 each comprise a set of mutually insulated electrodes with mutually different voltages. By applying a sufficiently high voltage gradient to the adjacent electrodes, the opposing sets of electrodes are used to apply sufficiently strong electric fields in a strategic fashion to cause favorable shear flows in the SOL of the FRC plasma. These voltages produce E×B shear flows that are primarily in the azimuthal direction of the SOL plasma. When the shear flow velocity v_{θ}′ exceeds a certain value that is related to parameters, such as, e.g., the FRC density gradient length, the plasma in the SOL tends to behave well both in its stability and transport as has been proposed and observed in tokamaks (see Ref. [1]). In the FRC, similar but distinct measures are taken to instill better behavior in stability and transport by a set of imposed shear conditions discussed below.

In particular, the proposed electrode configurations discussed below can stabilize a set of instabilities called drift wave instabilities in the SOL region of the FRC plasma under certain conditions with sufficiently strong shear. Without the proposed electrode configurations, the drift wave instabilities in the SOL tend to be generally unstable. However, under certain conditions, the drift wave instabilities are less unstable, even if they are not fully stabilized. In either case this should improve the plasma stability as well as the transport of particles and heat across the magnetic fields. Because the core plasma of the FRC plasma has been shown to be stable against drift wave instabilities (see Ref. [2]), while the SOL of the FRC plasma remains unstable without the shear flow, the method disclosed herein realizes a potentially drift wave free magnetically isolated (confined) plasma, which is seldom encountered. Special attention is paid not only to the shear and its size (as paid attention to in tokamak cases) but also the polarity or profile of the voltage. The latter is related to the performance of the divertors and the divertor related control of the transport of particles and subsequent plasma behavior.

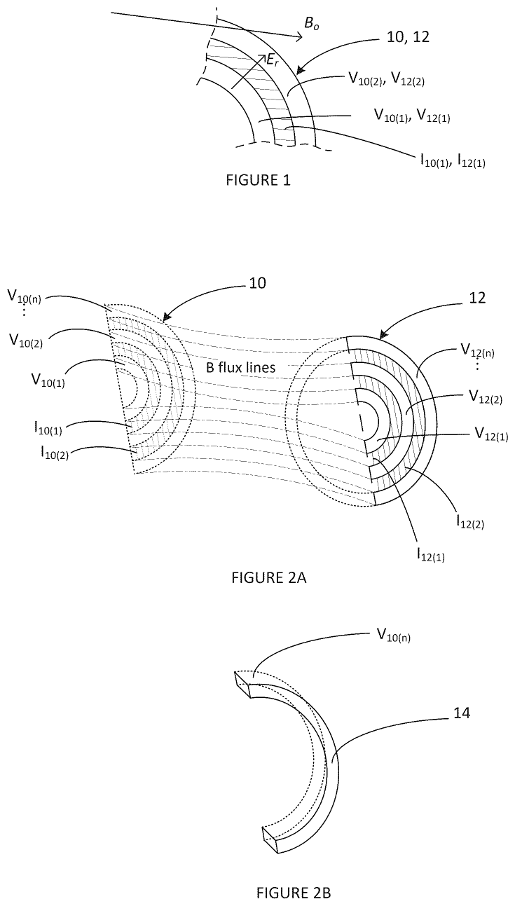

Turning to FIGS. 1 and 2, example embodiments of the opposing sets of electrodes 10 and 12 are depicted. In example configurations, individual electrodes of the opposing sets of electrodes 10 and 12, such as, e.g., V₁₀₍₁₎ and V₁₂₍₁₎, V₁₀₍₂₎ and V₁₂₍₂₎, and V₁₀₍ₙ₎ and V₁₂₍ₙ₎, are aligned across from each other along the magnetic flux lines B so that when the FRC plasma conducts current by arcing, the current has to run across magnetic field Bₒ, thus reducing the conducting breakdown (a phenomenon similar to lightening propagation and the auroral formation). In each set of opposing electrodes 10 and 12, first or inner electrodes V₁₀₍₁₎ and V₁₂₍₁₎ (which may follow a certain class of flux function), are axially positioned with and annularly spaced apart from second electrodes V₁₀₍₂₎ and V₁₂₍₂₎. The first electrodes V₁₀₍₁₎ and V₁₂₍₁₎ are separated from the second electrodes V₁₀₍₂₎ and V₁₂₍₂₎ by robustly stable insulators I₁₀₍₁₎ and I₁₂₍₁₎. Robustly stable insulators I₁₀₍₂₎ and I₁₂₍₂₎ separate the second electrodes V₁₀₍₂₎ and V₁₂₍₂₎ from the next annularly spaced electrodes. This annular structure or configuration is repeated N layers out to outer electrodes V₁₀₍ₙ₎ and V₁₂₍ₙ₎. With mutually insulated electrodes with mutually different voltages, this annular structure or configuration enables the voltages Vᵢ of the electrodes V₁₀₍₁₎, V₁₀₍₂₎ . . . V₁₀₍ₙ₎ and V₁₂₍₁₎, V₁₂₍₂₎ . . . V₁₂₍ₙ₎ to vary not only in size but also polarity.

$${E}_{r}^{( n )} ∼ \frac{{v}_{n + 1} - {v}_{n}}{Δ r}$$

$${V}_{{θ}_{( n )}}^{′} ∼ \frac{{E}_{r}^{( n + 1 )} - {E}_{r}^{( n )}}{Δ r}$$

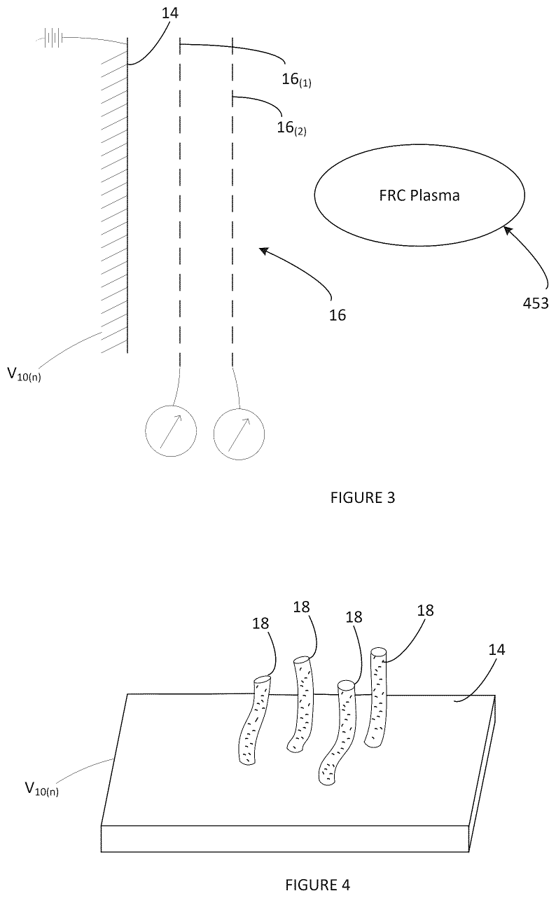

Referring to FIG. 3, in example embodiment, some or all of the electrodes V₁₀₍₁₎, V₁₀₍₂₎ . . . V₁₀₍ₙ₎ and V₁₂₍₁₎, V₁₂₍₂₎ . . . V₁₂₍ₙ₎ may have additional surface treatment to the plasma facing conducting surface 14 (see FIG. 2B), including, e.g. a grid or mesh 16 or set of grids 16₍₁₎ and 16₍₂₎, positioned between the plasma facing conducting surface 14 and the FRC plasma 453. The voltage of the grid 16 or set of grids 16₍₁₎ and 16₍₂₎ may controlled or adjusted according to the plasma conditions and surface conditions of the electrodes V₁₀₍₁₎, V₁₀₍₂₎ . . . V₁₀₍ₙ₎ and V₁₂₍₁₎, V₁₂₍₂₎ . . . V₁₂₍ₙ₎. Such a configuration may be similar to a triode (see Ref. [3]).

In another example embodiment, as depicted in FIG. 4, the plasma facing conducting surface 14 of an electrode V₁₀₍₁₎, V₁₀₍₂₎ . . . V₁₀₍ₘ₎ and V₁₂₍₁₎, V₁₂₍₂₎ . . . V₁₂₍ₘ₎ includes a material that provides an ease of discharge capability. In the example embodiment, the surface 14 includes a plurality (or forest) of pointed filaments or fingers comprising, e.g., electrically-conducting carbon nanotube filamentary fingers 18 extending there from (see Refs. [4,5]).

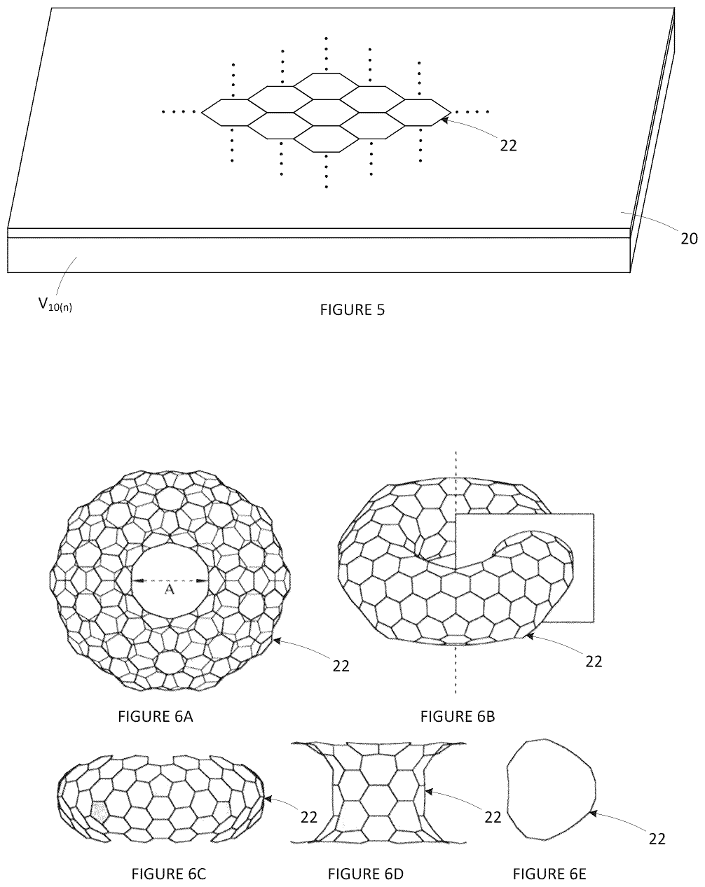

Turning to FIG. 5, in an example, the insulating layer 20 positioned adjacent an electrode V₁₀₍₁₎, V₁₀₍₂₎ . . . V₁₀₍ₙ₎ and V₁₂₍₁₎, V₁₂₍₂₎ . . . V₁₂₍ₙ₎ includes a material whose electronic bonds are saturated, preferably by covalent chemical bonds without impurities. In one example, a two-dimensional carbon structure of graphene 22 (see Ref. [6]) is utilized as the insulating material 20. In another example, a carbon net 22 (see Refs. [7-11]), as shown in FIGS. 6A-6E, is utilized. In such carbon nets 22, the carbon atoms are connected via saturated covalent bonds (in basically 2-dimensional fashion, maximizing the insularity against the electric breakdown.

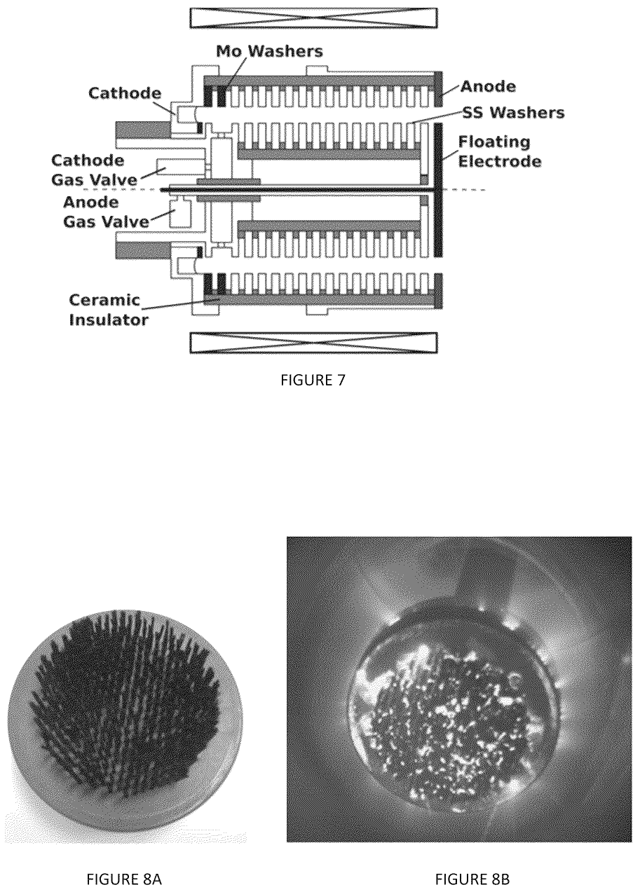

In addition to utilizing opposing sets of electrodes to facilitate imposing shear flows to control the FRC plasma, co-axial plasma guns or electron guns may be utilized. An axial plasma gun (or end-on plasma gun) (see Refs. [12,13]), an example of which is shown in FIG. 7, can generate either hot or cold plasma stream that can also produce a radial electric field (Eᵣ) in open-field-line plasmas (see Refs. [13,14]). The generated radial electric field propagates to the SOL plasma of FRC through open-field lines that can control plasma rotation as well as stabilize plasma.

Alternatively, an open-field-line or SOL plasma surrounding the FRC can be controlled and heated by electron gun (or beam) (see Ref. [15]), an example of which is shown in FIGS. 8A and 8B. Electron-beam injection into FRC/SOL plasmas also raises the novel possibility of trapping the high energy beam particles in the cusp-like fields at the ends of the FRC and, at sufficiently high beam energy, penetrating into the closed-field-line region of the plasma (FRC core).

A detailed discussion regarding systems, devices, and methods that may be used in conjunction with the systems, devices, and methods described herein is provided in PCT Application No. PCT/US17/59067, filed Oct. 30, 2017, entitled Systems and Methods for Improved Sustainment of a High Performance FRC Elevated Energies Utilizing Neutral Beam Injectors With Tunable Beam Energies, which application is incorporated by reference as if set forth in full.

Various aspects of the present subject matter are set forth below, in review of, and/or in supplementation to, the embodiments described thus far, with the emphasis here being on the interrelation and interchangeability of the following embodiments. In other words, an emphasis is on the fact that each feature of the embodiments can be combined with each and every other feature unless explicitly stated otherwise or logically implausible.

Processing circuitry can include one or more processors, microprocessors, controllers, and/or microcontrollers, each of which can be a discrete or stand-alone chip or distributed amongst (and a portion of) a number of different chips. Any type of processing circuitry can be implemented, such as, but not limited to, personal computing architectures (e.g., such as used in desktop PC's, laptops, tablets, etc.), programmable gate array architectures, proprietary architectures, custom architectures, and others. Processing circuitry can include a digital signal processor, which can be implemented in hardware and/or software. Processing circuitry can execute software instructions stored on memory that cause processing circuitry to take a host of different actions and control other components.

Processing circuitry can also perform other software and/or hardware routines. For example, processing circuitry can interface with communication circuitry and perform analog-to-digital conversions, encoding and decoding, other digital signal processing, multimedia functions, conversion of data into a format (e.g., in-phase and quadrature) suitable for provision to communication circuitry, and/or can cause communication circuitry to transmit the data (wired or wirelessly).

Any and all signals described herein can be communicated wirelessly except where noted or logically implausible. Communication circuitry can be included for wireless communication. The communication circuitry can be implemented as one or more chips and/or components (e.g., transmitter, receiver, transceiver, and/or other communication circuitry) that perform wireless communications over links under the appropriate protocol (e.g., Wi-Fi, Bluetooth, Bluetooth Low Energy, Near Field Communication (NFC), Radio Frequency Identification (RFID), proprietary protocols, and others). One or more other antennas can be included with communication circuitry as needed to operate with the various protocols and circuits. In some embodiments, communication circuitry can share antenna for transmission over links. Processing circuitry can also interface with communication circuitry to perform the reverse functions necessary to receive a wireless transmission and convert it into digital data, voice, and/or video. RF communication circuitry can include a transmitter and a receiver (e.g., integrated as a transceiver) and associated encoder logic.

Processing circuitry can also be adapted to execute the operating system and any software applications, and perform those other functions not related to the processing of communications transmitted and received.

Computer program instructions for carrying out operations in accordance with the described subject matter may be written in any combination of one or more programming languages, including an object oriented programming language such as Java, JavaScript, Smalltalk, C++, C#, Transact-SQL, XML, PHP or the like and conventional procedural programming languages, such as the “C” programming language or similar programming languages.

Memory, storage, and/or computer readable media can be shared by one or more of the various functional units present, or can be distributed amongst two or more of them (e.g., as separate memories present within different chips). Memory can also be a separate chip of its own.

To the extent the embodiments disclosed herein include or operate in association with memory, storage, and/or computer readable media, then that memory, storage, and/or computer readable media are non-transitory. Accordingly, to the extent that memory, storage, and/or computer readable media are covered by one or more claims, then that memory, storage, and/or computer readable media is only non-transitory. The terms “non-transitory” and “tangible” as used herein, are intended to describe memory, storage, and/or computer readable media excluding propagating electromagnetic signals, but are not intended to limit the type of memory, storage, and/or computer readable media in terms of the persistency of storage or otherwise. For example, “non-transitory” and/or “tangible” memory, storage, and/or computer readable media encompasses volatile and non-volatile media such as random access media (e.g., RAM, SRAM, DRAM, FRAM, etc.), read-only media (e.g., ROM, PROM, EPROM, EEPROM, flash, etc.) and combinations thereof (e.g., hybrid RAM and ROM, NVRAM, etc.) and variants thereof.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

As used herein and in the appended claims, the singular forms “a,” “an,” and “the” include plural referents unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

### REFERENCES

[1] Y. Kishimoto et al., “Theory of self-organized critical transport in tokamak plasmas”, Phys. Plasmas 3, 1289 (1996).
[2] C. K. Lau et al., “Drift-wave instability in the field-reversed configuration”, Phys. Plasmas 24, 082512 (2017).
[3] J. A. Fleming (1904).
[4] S. Iijima, “Helical microtubules of graphitic carbon”, Nature 354, 56 (1991).
[5] P. M. Ajayan and S. Iijima, “Capillarity-induced filling of carbon nanotubes”, Nature 361, 333 (1993).
[6] A. K. Geim and K. S. Novoselov, “The rise of graphene”, Nature Mater. 6, 183 (2007).
[7] S. Itoh et al., “Toroidal form of carbon C₃₆₀”, Phys. Rev. B 47, 1703 (1993).
[8] S. Ihara et al., “Helically coiled cage forms of graphitic carbon”, Phys. Rev. B 48, 5643 (1993).
[9] S. Itoh and S. Ihara, “Toroidal forms of graphitic carbon. II. Elongated tori”, Phys. Rev. B 48, 8323 (1993).
[10] S. Itoh and S. Ihara, “Isomers of the toroidal forms of graphitic carbon”, Phys. Rev. B 49, 13970 (1994).
[11] S. Iijima et al., “Growth model for carbon nanotubes”, Phys. Rev. Lett. 69, 3100 (1992).
[12] G. I. Dimov et al., Sov. J. Plasma Phys. 8, 546 (1982).
[13] M. Tuszewski et al., “A new high performance field reversed configuration operating regime in the C-2 device”, Phys. Plasmas 19, 056108 (2012).
[14] M. W. Binderbauer et al., “A high performance field-reversed configuration”, Phys. Plasmas 22, 056110 (2015).
[15] M. C. Thompson et al., “Electron-Beam Heating Experiments on the C-2 Field-Reversed Configuration Device”, Bull. Am. Phys. Soc. 58, GP8.00051 (2013).
[16] T. Tajima and K. Shibata, “Plasma Astrophysics”, (Addison-Wesley, Reading, MA, 1997). Reprinted (Perseus, Boulder, CO, 2002).
[17] M. W. Binderbauer et al., U.S. Pat. No. 10,743,398, “Systems and methods for forming and maintaining a high performance FRC”.
[18] H. L. Berk, H. Momota, and T. Tajima, “Plasma current sustained by fusion charged particles in a field-reversed configuration”, Phys. Fluids 30, 3548 (1987).

1. A method for maintaining a magnetically confined field reversed configuration (FRC) plasma comprising the steps of:
injecting beams of fast neutral atoms from neutral beam injectors into the FRC plasma at an angle towards the mid-plane of the confinement chamber, and
controlling the radial electric field profile in an edge layer of the FRC plasma by applying a distribution of electric potential to a group of open flux surfaces of the FRC with opposing sets of biasing electrodes, wherein each set of biasing electrodes includes a plurality of mutually insulated electrodes.

2. The method of claim 1, wherein the step of controlling the radial electric field profile includes applying mutually different voltages to individual ones of the plurality of mutually insulated electrodes.

3. The method of claim 1, wherein an individual electrode of the plurality of mutually insulated electrodes includes a grid or set of grids positioned adjacent a plasma facing or conducting surface of the individual electrode.

4. The method of claim 1, wherein an individual electrode of the plurality of mutually insulated electrodes includes a plurality of electrically-conducting carbon nanotube filamentary fingers extending from a plasma facing or conducting surface of the electrode.

5. The method of claim 1, wherein an individual electrode of the plurality of mutually insulated electrodes includes an insulating material comprising a carbon structure affixed to the electrode.

6. The method of claim 5, wherein the insulating material comprises a carbon net.

7. The method of claim 5, wherein the insulating material comprises a two-dimension carbon structure of graphene.

8. The method of claim 1, further comprising the step of merging compact toroid plasmas and forming an FRC about the merged plasma in a confinement chamber.

9. The method of claim 1 wherein the step of injecting beams of fast neutral atoms includes one of the step of tuning the beam energies of the plurality of neutral beams between a first beam energy and a second beam energy, wherein the second beam energy differs from the first beam energy, or the step of tuning the beam energies of the plurality of neutral beams between a first beam energy and a second beam energy, wherein the second beam energy differs from the first beam energy, and wherein the second beam energy is higher than the first beam energy, or the step of tuning the beam energies of the plurality of neutral beams between a first beam energy and a second beam energy, wherein the second beam energy differs from the first beam energy, and wherein the plurality of neutral beams switch between the first and second beam energies during the duration of an injection shot.

10. The method of claim 1 further comprising one of the step of generating a magnetic field within the chamber with quasi-dc coils extending about the chamber or the step of generating a magnetic field within the chamber with quasi-dc coils extending about the chamber and generating a mirror magnetic field within opposing ends of the chamber with quasi-dc mirror coils extending about the opposing ends of the chamber.

11. The method of claim 1 wherein the step of the forming the FRC includes forming a formation FRC in a formation section coupled to an end of the confinement chamber and accelerating the formation FRC towards the mid-plane of the chamber to form the FRC.

12. The method of claim 11 wherein the step of the forming the FRC includes forming a second formation FRC in a second formation section coupled to a second end of the confinement chamber and accelerating the second formation FRC towards the mid-plane of the chamber where the two formation FRCs merge to form the FRC.

13. The method of claim 11 wherein the step of forming the FRC includes one of forming a formation FRC while accelerating the formation FRC towards the mid-plane of the chamber and forming a formation FRC then accelerating the formation FRC towards the mid-plane of the chamber.

14. The method of claim 12 further comprising the step of guiding magnetic flux surfaces of the FRC into diverters coupled to the ends of the formation sections.

15. The method of claim 11 further comprising the step of guiding magnetic flux surfaces of the FRC into a diverter coupled to the end of the formation section.

16. The method of claim 15 further comprising the step of guiding magnetic flux surfaces of the FRC into a second diverter coupled to the end of the chamber opposite the formation section.

17. The method of claim 14 further comprising the step of generating a magnetic field within the formation sections and diverters with quasi-dc coils extending about the formation sections and diverters.

18. The method of claim 14 further comprising the step of generating a mirror magnetic field between the formation sections and the diverters with quasi-dc mirror coils.

19. The method of claim 18 further comprising step of generating a mirror plug magnetic field within a constriction between the formation sections and the diverters with quasi-dc mirror plug coils extending about the constriction between the formation sections and the diverters.

20. The method of claim 1 further comprising the step of generating one of a magnetic dipole field and a magnetic quadrupole field within the chamber with saddle coils coupled to the chamber.

21-33. (canceled)
